(19) United States
(12) Patent Application Publication
(10) Pub. No.: US 2013/0286872 A1
(43) Pub. Date: Oct. 31, 2013

(54) SESSION-BASED TRAFFIC ANALYSIS SYSTEM

(71) Applicant: Kyu-Min Choi, Seoul (KR)

(72) Inventor: Kyu-Min Choi, Seoul (KR)

(73) Assignee: PLUSTECH INC., Seoul (KR)

(21) Appl. No.: 13/882,724

(22) PCT Filed: Nov. 7, 2011
(86) PCT No.: PCT/KR2011/008413

§ 371 Date: Jul. 15, 2013

(30) Foreign Application Priority Data
Nov. 9, 2010 (KR) 10-2010-0111031

(51) Int. Cl. H04L 12/26

(52) U.S. Cl. CPC H04L 43/08
USPC 370/252

(57) ABSTRACT

The present invention relates to a session-based traffic analysis system that may accurately analyze an amount of traffic for each transmission control protocol (TCP) connection using only one-way packets. The system may accurately analyze an amount of two-way traffic using only one-way connection information.

### TECHNICAL FIELD

The present invention relates to a broadband traffic analysis system, and more particularly, to a traffic analysis system which analyzes, in detail, an entirety of an amount of upstream traffic and an amount of downstream traffic by comparing and analyzing a sequence number value and an acknowledgement number value of one-way traffic of two-way traffic to solve an issue in that an entirety of upstream traffic and downstream traffic need to be collected and analyzed in order for upstream traffic and downstream traffic transmitted over a broadband network to be analyzed.

### BACKGROUND ART

In recent times, the Internet may be easily used by anyone due to a drastic development and propagation of Internet technology.

Accordingly, a number of Internet users is rapidly increasing, and methods for connecting to the Internet and usage patterns of the Internet have become complex and diversified.

In addition, a broadband network for providing the Internet is complicated, and an Internet usage pattern is also diversified. Thus, a professional traffic analysis system is required to manage and operate a traffic network as an amount of traffic usage significantly increases due to the rapid increase and the drastic propagation of Internet users.

Here, the traffic analysis system refers to a system for analyzing a statistical amount of traffic, a current state of an Internet connection, a number of transmission control protocol (TCP) connection sessions, and a traffic usage for each service to analyze an increasing amount of traffic in the broadband network, and to analyze a factor causing interference against the network.

However, hundreds or thousands of high-cost and high-capacity traffic analysis systems are required to professionally analyze an entirety of upstream traffic and downstream traffic in the broadband network through segmentation. Accordingly, not only construction costs but also high costs for maintaining and repairing are incurred as a traffic rate increases. Thus, introducing a system for analyzing an entirety of the upstream traffic and the downstream traffic in the broadband network is difficult, in terms of costs and maintenance.

To solve the aforementioned issue, a traffic sample analysis method installed in a partial section of the broadband network to analyze traffic is currently adopted as a method for analyzing rapidly increasing high-capacity traffic of the broadband network. The traffic sample analysis method may eliminate the above-described issues in terms of costs and maintenance, which may result from using a plurality of analytical systems. However, traffic analysis is possible using only an extracted traffic sample, in lieu of the entirety of traffic. Accordingly, a result of the analysis may differ from an actual amount of traffic analysis and as a result, numerous errors in measurement may occur.

Accordingly, to overcome issues found in conventional high-cost and high-capacity traffic analysis systems, traffic sample analysis systems, and the like, there is a need for a traffic analysis method that may construct an efficient high-capacity traffic analysis system at low costs. However, a method satisfying all the requirements has yet to be proposed.

### DISCLOSURE OF INVENTION

### Technical Goals

An aspect of the present invention provides a session-based traffic analysis system which may replace a plurality of high-cost and high-capacity traffic analysis systems with a low-cost and efficient traffic analysis system, and may measure a total amount of traffic by analyzing a portion of upstream traffic that occupies about ⅓ of the total traffic in a broadband network.

Another aspect of the present invention provides a session-based traffic analysis system which may accurately analyze an amount of traffic for each transmission control protocol (TCP) connection using only some one-way packets based on TCP connection-oriented characteristics, that is, connection information of data storage for each TCP connection, and may accurately analyze an amount of two-way traffic using only some one-way connection information, as an amount of TCP data transmission to be transmitted is calculated based on a sequence number of the TCP connection information, and an amount of received TCP data transmission is calculated based on an acknowledgement number of the TCP connection information.

### Technical Solutions

According to an aspect of the present invention, there is provided a session-based traffic analysis system to analyze two-way traffic based on one-way traffic, with respect to broadband traffic using a transmission control protocol (TCP), the system including a traffic mirroring means to monitor the one-way traffic transmitted from a broadband network on the TCP, the one-way traffic corresponding to upstream traffic or downstream traffic, a session information extracting means to extract a sequence number and an acknowledgement number for each set of session information from the traffic monitored by the traffic mirroring means, a two-way traffic analyzing means to update an initial value and a final value for each of the sequence number and the acknowledgement number extracted by the session information extracting means, to determine an amount of traffic transmitted in a direction traffic is collected in based on the initial value and the final value of the sequence number, and to determine an amount of traffic transmitted in a direction opposite to the direction traffic is collected in based on the initial value and the final value of the acknowledgement number, and a storage medium to periodically log and store a traffic analysis result value obtained by the traffic analyzing means.

The session information extracting means may extract, from TCP header information of the traffic, sequence information to be used as a sequence number value, acknowledgement information to be used as an acknowledgement number value, and source Internet protocol (IP)/destination IP/source port/destination port values of an IP header and a TCP header to be used as a session information value.

The two-way traffic analyzing means may store a sequence number and an acknowledgement number of a session information value initially collected as initial values of the sequence number and the acknowledgement number, and may continuously store sequence numbers and acknowledgement numbers collected thereafter for the same session information value, as final values of the sequence number and the acknowledgement number.

The two-way traffic analyzing means may calculate the initial values and the final values of the sequence number and the acknowledgement number, may determine an amount of data transmitted in the direction the traffic is collected in based on an equation “final value of sequence number—initial value of sequence number”, and may determine an amount of data received in the direction opposite to the direction the traffic is collected in based on an equation “final value of acknowledgment number—initial value of acknowledgment number”.

### Advantageous Effects

According to embodiments of the present invention, the same analysis result value as a value obtained by analyzing total traffic may be induced by analyzing only a portion of upstream traffic that occupies about ⅓ of the total traffic, instead of analyzing the total traffic of a broadband network.

Accordingly, more than ⅓ of the number of traffic analysis servers required in the related art may be decreased. According to the decrease in the number of traffic analysis servers, costs for purchasing a traffic analysis server, or additional costs and range of management may be reduced. Accordingly, there may be provided a broadband network management method which is efficient in terms of time and costs.

Further, according to embodiments of the present invention, there may be provided a broadband network traffic analysis system using a low-capacity and general-purpose server capable of correcting a traffic analysis value, although a portion of TCP packets is missing while analyzing the traffic.

### BRIEF DESCRIPTION OF DRAWINGS

FIG. 1 is a configuration diagram illustrating a state in which a session-based traffic analysis system according to an embodiment of the present invention is applied to a network.

FIG. 2 is a diagram illustrating a configuration of an Internet protocol (IP) header of an IP packet for extracting values of a source IP and a destination IP from among session values.

FIG. 3 is a diagram illustrating a configuration of a TCP header of an IP packet for extracting values of a source port, a destination port, a sequence number, and an acknowledgement number from among session values.

FIG. 4 illustrates a session information storage table for managing a session value, and values of a sequence number and an acknowledgement number extracted from the IP packet as an initial value and a final value.

FIG. 5 is a flowchart illustrating a session-based traffic analysis process according to an embodiment of the present invention.

### BEST MODE FOR CARRYING OUT THE INVENTION

Provided is a session-based traffic analysis system to analyze two-way traffic based on one-way traffic, with respect to broadband traffic using a transmission control protocol (TCP). The system includes a traffic mirroring means to monitor the one-way traffic, more particularly, upstream traffic or downstream traffic transmitted from a broadband network to TCP. The system also includes a session information extracting means to extract a sequence number and an acknowledgement number for each set of session information from the traffic monitored by the traffic mirroring means. The system also includes a two-way traffic analyzing means. The two-way traffic analyzing means updates an initial value and a final value for each of the sequence number and the acknowledgement number extracted by the session information extracting means. The two-way traffic analyzing means determines an amount of traffic transmitted in a direction traffic is collected in based on the initial value and the final value of the sequence number. The two-way traffic analyzing means determines an amount of traffic transmitted in a direction opposite to the direction traffic is collected in based on the initial value and the final value of the acknowledgement number. The system also includes a storage medium to periodically log and store a traffic analysis result value obtained by the traffic analyzing means.

### Mode for Carrying Out the Invention

Hereinafter, a session-based traffic analysis system according to embodiments of the present invention will be described in detail with reference to the accompany drawings.

Here, the following description is only an example of implementation of the present invention and thus, the present invention is neither limited thereto nor restricted thereby.

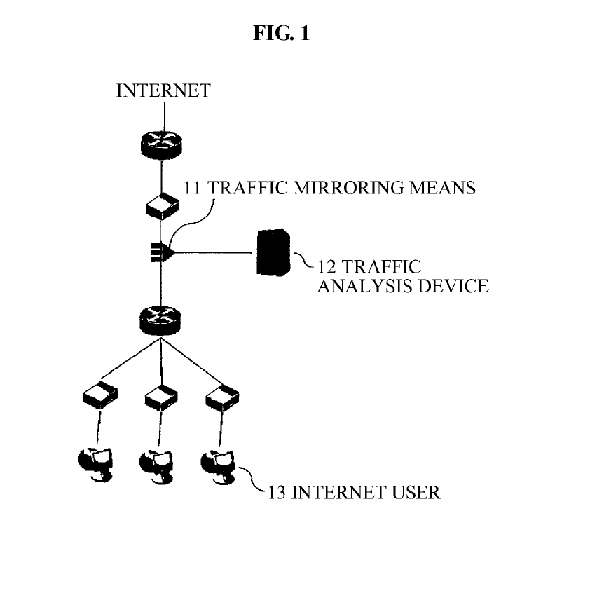

FIG. 1 is a configuration diagram of a network system illustrating a state in which a corresponding system performing a session-based traffic analysis method according to an embodiment of the present invention is applied to a network.

As illustrated in FIG. 1, to analyze traffic occurring with respect to an Internet user 13, a session-based traffic analysis system according to an embodiment of the present invention includes a traffic mirroring means 11 to lead traffic into a traffic analysis device 12 using a tab, a switch device, and the like, and the traffic analysis device 12 to analyze the lead traffic based on a session.

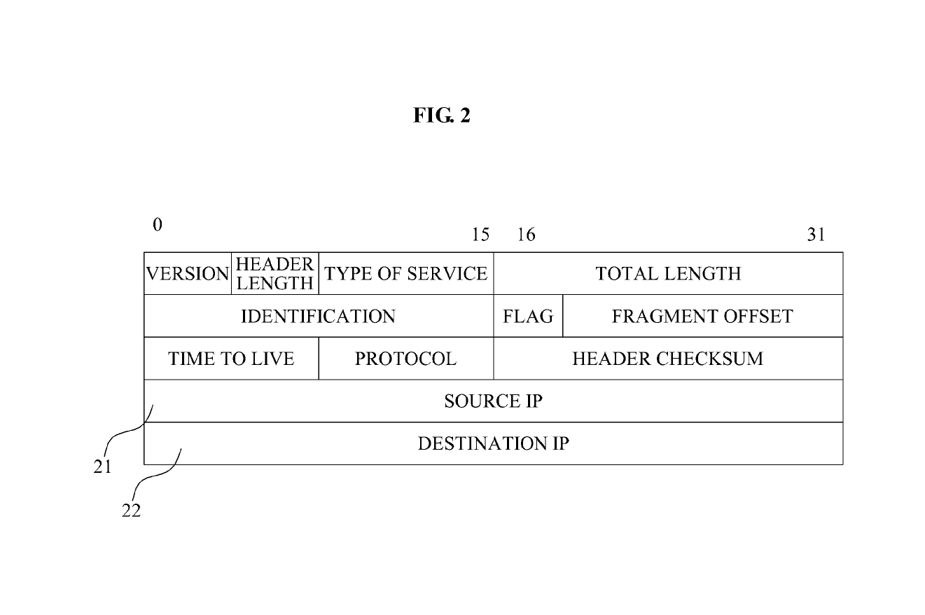

FIG. 2 is a diagram illustrating a configuration of an Internet protocol (IP) header of a packet which is analyzed when a source IP 21 and a destination IP 22 are extracted from among session information values.

The source IP 21 of FIG. 2 indicates an IP address of a transmitter which transmits data, and the destination IP 22 indicates an IP address of a receiver which receives data.

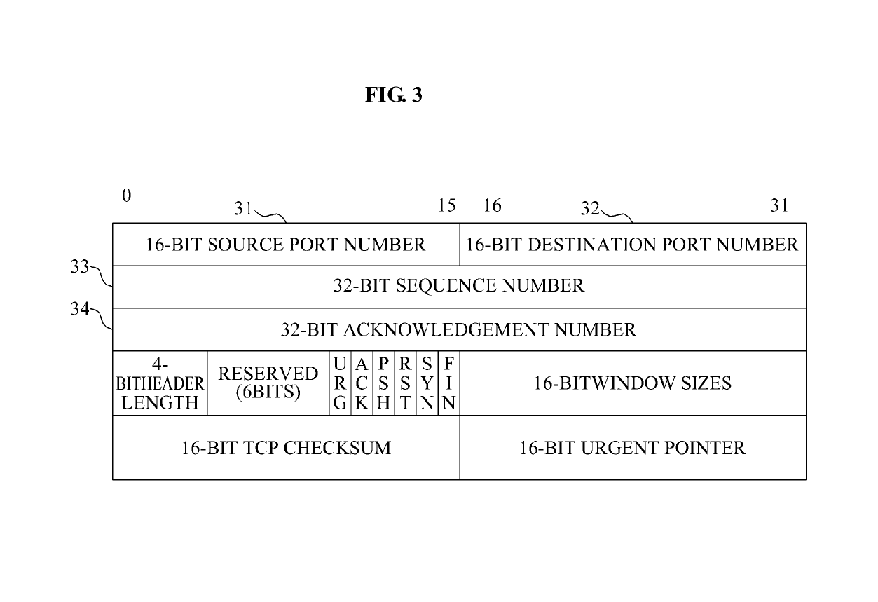

FIG. 3 is a diagram illustrating a configuration of a transmission control protocol (TCP) header of a packet which is analyzed when information of a source port 31 and a destination port 32, and a sequence number 33 and an acknowledgement number 34 for the session-based traffic analysis are extracted from among session information values.

The source port 31 indicates a connection number of a data transmitter, and the destination port 32 indicates a connection number of a data receiver.

The sequence number 33 is a serial number which is assigned in an order when data to be transmitted through a network is divided into packets.

The acknowledgement number 34 is a serial number of received data.

Here, the sequence number is the serial number of data to be transmitted and thus, an increase in a value between an initially collected sequence number value and a finally collected sequence number value based on session information indicates an amount of data actually transmitted with respect to corresponding session information.

In addition, the acknowledgement number is the serial number of received data and thus, an increase in a value between an initially collected acknowledgement number value and a finally collected acknowledgement number value based on session information indicates an amount of data actually received with respect to corresponding session information.

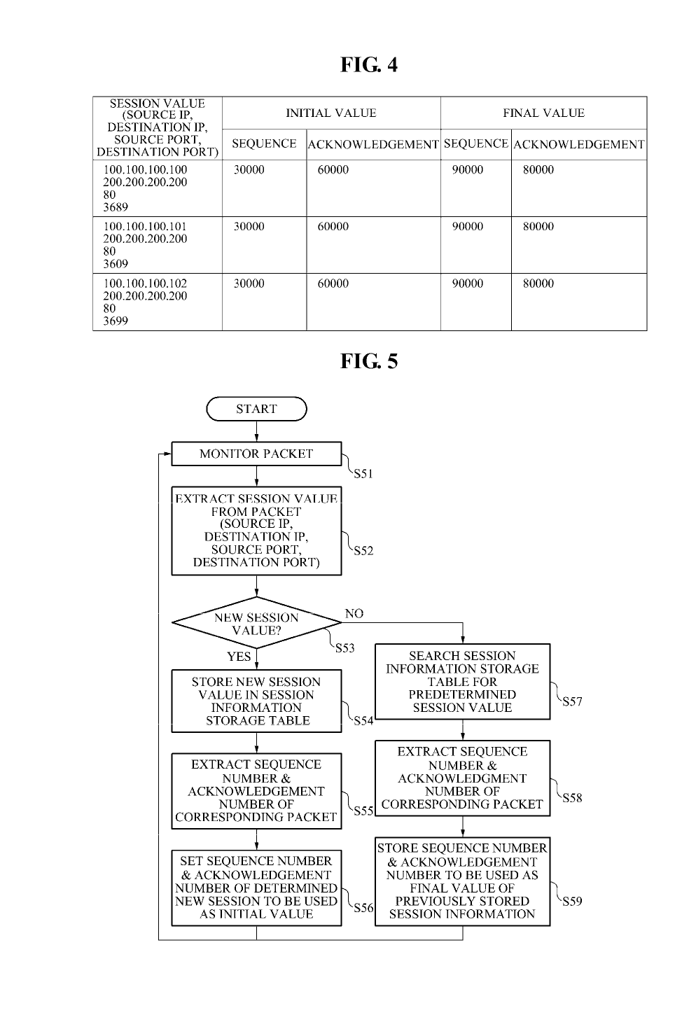

FIG. 4 is a session information storage table storing an initial sequence number value, a final sequence number value, an initial acknowledgement number value, and a final acknowledgement value for each set of session information.

Using values stored in the session information storage table, an amount of data transmitted by a corresponding session is calculated based on an equation of “final value of sequence number—initial value of sequence number”, and an amount of data received by the corresponding session is calculated based on an equation “final value of acknowledgment number—initial value of acknowledgment number”.

Here, the initial sequence number value stores a sequence number value which is extracted when a minimum packet having a session value is collected.

The final sequence number value is maintained by continuously updating, to be used as the final sequence number value, a sequence number value of a corresponding packet extracted when a packet having the same session value as an initial session value is collected because a packet having the initial session value is already collected.

Further, the initial acknowledgement number value stores the sequence number value extracted when a minimum packet having a session value is already collected.

The final acknowledgement number value is maintained by continuously updating, to be used as the final acknowledgement number value, an acknowledgement number value of a corresponding packet extracted when a packet having the same session value as the initial session value is collected because the packet having an initial session value is already collected.

FIG. 5 is a flowchart illustrating a session-based traffic analysis process.

As illustrated in FIG. 5, the session-based traffic analysis process in the broadband network according to an embodiment of the present invention generates a session value key by monitoring a packet transmitted on a network in operation S51, and by extracting a session value, more particularly, information about a source IP, a destination IP, a source port, and a destination port included in the monitored packet in operation S52.

Whether the generated session value is a session value present in the session information storage table or a new session value may be determined in operation S53.

When the corresponding session value is determined to be the new session value absent in the session information storage table, the extracted new session value is stored in the session information storage table in operation S54. A sequence number and an acknowledgement number of the corresponding packet are extracted in operation S55. The extracted sequence number and acknowledge number are stored in the session information storage table to be used as an initial value of the stored new session value in operation S56.

Conversely, when the corresponding session value is determined to be present in the session information storage table, the session information storage table is searched for an existing session value in operation S57.

In operation S58, the sequence number and the acknowledgement number of the corresponding packet are extracted,

In operation S59, the extracted sequence number and acknowledge number are stored in the session information storage table to be used as a final value of the previously stored session information.

The initial value and the final value of the sequence number, and the initial value and the final value of the acknowledgement number are stored in the session information storage table for each session value of all packets by repeatedly performing operations S56 and S59 for each packet being monitored.

In addition, based on session values stored in the session information storage table through the aforementioned process, a traffic analysis value, for example, a data transmission amount and a data reception amount may be calculated according to the following equations.

Data transmission amount=final value of sequence number−initial value of sequence number

Data reception amount=final value of acknowledgement number−initial value of acknowledgement number

As described above, although the session-based traffic analysis system in the broadband network according to embodiments of the present invention is described, the present invention is neither limited thereto nor restricted thereby.

Although an installation is described to be performed in the session-based analysis device 12 in the above-mentioned embodiment, the present invention may be configured as a system which may perform predetermined processes as described above and is independent in terms of hardware. For example, the present invention may be provided in a form of software, such as an application installed on a server side or a client side to operate in a broadband network analysis and to operate by requesting a traffic analysis.

Here, when the present invention is provided in the form of software as described above, the present invention may be provided in various forms based on necessity. For example, the present invention may be provided in a form of a record medium in which a program executing the above-mentioned predetermined processes is stored, or in a form of a download program to be downloaded and installed through the Internet.

Accordingly, the present invention is not limited to the above-described embodiments. Instead, it would be appreciated by those skilled in the art that changes may be made to these embodiments without departing from the principles and spirit of the invention, the scope of which is defined by the claims and their equivalents.

### INDUSTRY APPLICABILITY

According to embodiments of the present invention, there may be provided a session-based traffic analysis system which may replace conventional high-cost and high-capacity traffic analysis systems and traffic sample analysis systems, and may measure a total amount of traffic by analyzing a portion of upstream traffic that occupies about ⅓ of the total traffic in a broadband network to manage an efficient high-capacity traffic analysis system at low costs.

According to other embodiments of the present invention, there may be also provided a session-based traffic analysis system which may accurately analyze an amount of traffic for each transmission control protocol (TCP) connection using only some one-way packets based on TCP connection-oriented characteristics, more particularly, connection information of data storage for each TCP connection, and may accurately analyze an amount of two-way traffic using only some one-way connection information, as an amount of TCP data transmission to be transmitted is calculated based on a sequence number of the TCP connection information, and an amount of received TCP data transmission is calculated based on an acknowledgement number of the TCP connection information.

1. A session-based traffic analysis system to analyze two-way traffic based on one-way traffic, with respect to broadband traffic using a transmission control protocol (TCP), the system comprising:
a traffic mirroring means to monitor the one-way traffic transmitted from a broadband network on the TCP, the one-way traffic corresponding to upstream traffic or downstream traffic;
a session information extracting means to extract a sequence number and an acknowledgement number for each set of session information from the traffic monitored by the traffic mirroring means;
a two-way traffic analyzing means to update an initial value and a final value for each of the sequence number and the acknowledgement number extracted by the session information extracting means, to determine an amount of traffic transmitted in a direction traffic is collected in based on the initial value and the final value of the sequence number, and to determine an amount of traffic transmitted in a direction opposite to the direction traffic is collected in based on the initial value and the final value of the acknowledgement number; and
a storage medium to periodically log and store a traffic analysis result value obtained by the traffic analyzing means.

2. The system of claim 1, wherein the session information extracting means extracts, from TCP header information of the traffic, sequence information to be used as a sequence number value, acknowledgement information to be used as an acknowledgement number value, and source Internet protocol (IP)/destination IP/source port/destination port values of an IP header and a TCP header to be used as a session information value.

3. The system of claim 1, wherein the two-way traffic analyzing means stores a sequence number and an acknowledgement number of a session information value initially collected as initial values of the sequence number and the acknowledgement number, and continuously stores sequence numbers and acknowledgement numbers collected thereafter for the same session information value, as final values of the sequence number and the acknowledgement number.

4. The system of claim 3, wherein
the two-way traffic analyzing means calculates the initial values and the final values of the sequence number and the acknowledgement number,
determines an amount of data transmitted in the direction the traffic is collected in based on an equation “final value of sequence number−initial value of sequence number”, and
determines an amount of data received in the direction opposite to the direction the traffic is collected in based on an equation “final value of acknowledgment number−initial value of acknowledgment number”.

5. A traffic analysis system, the system comprising:
a traffic mirroring unit for monitoring one-way traffic on a transmission control protocol (TCP), the one-way traffic corresponding to a first direction or a second direction;
a session information extracting unit for extracting a sequence number and an acknowledgement number for session information from the monitored one-way traffic; and
a two-way traffic analyzing unit for determining an amount of traffic in the first direction and an amount of traffic in the second direction based on the sequence number and the acknowledgement from the monitored one way traffic,
wherein traffic in the second direction is opposite to traffic in the first direction.

6. The system of claim 5, wherein the session information extracting unit
extracts the sequence number from a TCP header of the one-way traffic,
extracts the acknowledgement number from the TCP header of the one-way traffic, and
obtains the session information from a source Internet Protocol (IP) address, a destination IP address, a source port, and a destination port of the TCP header of the one-way traffic.

7. The system of claim 5, wherein the two-way traffic analyzing unit
determines an initial value of the sequence number and a final value of the sequence number,
determines an initial value of the acknowledgement number and a final value of the acknowledgement number,
determines an amount of traffic in a first direction based on the initial value of the sequence number and the final value of the sequence number, and
determines an amount of traffic in a second direction based on the initial value of the acknowledgement number and the final value of the acknowledgement number.

8. The system of claim 7, wherein the session information extracting unit
determines, to be the initial value of the sequence number, a sequence number initially collected for the session information, and
determines, to be the initial value of the acknowledgement number, an acknowledgement number initially collected for the session information.

9. The system of claim 8, wherein the session information extracting unit
updates, to be the final value of the sequence number, a sequence number collected subsequently for the session information as, and
updates, to be the final value of the acknowledgement number, an acknowledgement number collected subsequently for the session information.

10. The system of claim 7, wherein the two-way traffic analyzing unit
determines an amount of traffic in a first direction based on a difference between the initial value of the sequence number and the final value of the sequence number, and
determines an amount of traffic in a second direction based on a difference between the initial value of the acknowledgement number and the final value of the acknowledgement number.

11. The system of claim 5, further comprising;
a storage unit for periodically logging and storing a traffic analysis result obtained by the two-way traffic analyzing unit.

12. The system of claim 5, wherein
traffic in the second direction is downstream traffic when traffic in the first direction is upstream traffic, and
traffic in the second direction is upstream traffic when traffic in the first direction is downstream traffic.

13. A traffic analysis method, the method comprising:
monitoring one-way traffic on a transmission control protocol (TCP), the one-way traffic corresponding to traffic in a first direction or traffic in a second direction;
extracting a sequence number and an acknowledgement number for session information from the monitored one-way traffic; and
determining an amount of traffic in the first direction and an amount of traffic in the second direction traffic based on the sequence number and the acknowledgement from the monitored one way traffic,
wherein traffic in the second direction is opposite to traffic in the first direction traffic.

14. The method of claim 13, wherein the extracting of (the sequence number and the acknowledgement number comprises:
extracting the sequence number from a TCP header of the one-way traffic;
extracting the acknowledgement number from the TCP header of the one-way traffic; and
obtaining the session information from a source Internet Protocol (IP) address, a destination IP address, a source port, and a destination port of the TCP header of the one-way traffic.

15. The method of claim 13, wherein the determining of the amount of traffic in the first direction and the amount of traffic in the second direction comprises:
determining an initial value of the sequence number and a final value of the sequence number;
determining an initial value of the acknowledgement number and a final value of the acknowledgement number;
determining an amount of traffic in the first direction based on the initial value of the sequence number and the final value of the sequence number, and
determining an amount of traffic in the second direction based on the initial value of the acknowledgement number and the final value of the acknowledgement number.

16. The method of claim 15, wherein the extracting of the sequence number and the acknowledgement number comprises:
determining, to be the initial value of the sequence number, a sequence number initially collected for the session information, and
determining, to be the initial value of the acknowledgement number, an acknowledgement number initially collected for the session information.

17. The method of claim 16, wherein the extracting of the sequence number and the acknowledgement number further comprises:
updating, to be the final value of the sequence number, a sequence number collected subsequently for the session information as, and
updating, to be the final value of the acknowledgement number, an acknowledgement number collected subsequentlyr for the session information.

18. The method of claim 15, wherein
the determining of an amount of traffic in the first direction based on the initial value of the sequence number and the final value of the sequence number comprises:
determining an amount of traffic in the first direction traffic based on a difference between the initial value of the sequence number and the final value of the sequence number, and
the determining an amount of traffic in a second direction traffic based on the initial value of the acknowledgement number and the final value of the acknowledgement number comprises:
determining an amount of traffic in a second direction traffic based on a difference between the initial value of the acknowledgement number and the final value of the acknowledgement number.
